(19) United States
(12) Patent Application Publication
(10) Pub. No.: US 2026/0077805 A1
(43) Pub. Date: Mar. 19, 2026

(54) MODULAR ELECTRIC POWER STEERING UNIT WITH BEVEL INPUT FOR FLEXIBLE PACKAGING IN COMMERCIAL VEHICLES

(71) Applicant: ZF CV Systems Global GmbH, Bern (CH)

(72) Inventors: Joseph HARTER, Yorktown, IN (US); Praful BARI, West Lafayette, IN (US)

(21) Appl. No.: 18/888,280

(22) Filed: Sep. 18, 2024

(51) Int. Cl. B62D 5/04

(52) U.S. Cl. CPC B62D 5/0403; B62D 5/0421

(57) ABSTRACT

An electric power steering (EPS) system for a commercial vehicle includes an output section configured to mechanically couple with a first end of the output shaft, where a second end of the output shaft connects with a wheel assembly of the electric vehicle. The EPS also includes an input section having a vertical input end configured to mechanically couple with a first end of the input shaft, where a second end of the input shaft connects with a steering wheel assembly of the electric vehicle. The input section has a bevel box mechanically coupled to the vertical input end of the input section using an adapter plate, and the bevel box receives the first end of the input shaft at an angle with respect to the vertical input end of the input section.

The present disclosure relates to a steering column for a recreational vehicle.

### BACKGROUND

Electric power steering (EPS) is one of the fastest growing segments in commercial vehicle steering. Automobile manufacturers are moving from conventional hydraulic power steering systems to full electric power steering systems in commercial vehicles. In order to optimize vehicle designs, EPS systems are supposed to occupy similar space as rotary hydraulic systems along a frame rail. The space allocated for rotary hydraulic systems is limited, and does not have flexibility to accommodate new components that are to be added along with the EPS systems. Conventionally designed steering systems are configured to receive an input shaft only along a substantially vertical axis from the steering wheel assembly. The fixed configuration to receive the input shaft in this limited manner leads to a lack of flexibility in design of the EPS systems and does not allow for optimal use of space where the EPS is installed.

### SUMMARY

Embodiments of the present disclosure provide, in a first aspect, an electric power steering (EPS) system for a commercial vehicle is provided. The EPS system comprises: an output section configured to mechanically couple with a first end of the output shaft, wherein a second end of the output shaft is configured to connect with a wheel assembly of the electric vehicle; an input section having a vertical input end configured to mechanically couple with a first end of the input shaft, wherein a second end of the input shaft is configured to connect with a steering wheel assembly of the electric vehicle, wherein the input section further comprises: a bevel box mechanically coupled to the vertical input end of the input section using an adapter plate, the bevel box configured to receive the first end of the input shaft at an angle with respect to the vertical input end of the input section.

According to an implementation of the first aspect, the bevel box comprises an input to receive the first end of the input shaft.

According to an implementation of the first aspect, the angle at which the input of the bevel box is configured to receive the first end of the input shaft is ninety degrees with respect to the vertical input end of the input section.

According to an implementation of the first aspect, the angle at which the input of the bevel box is configured to receive the first end of the input shaft is forty-five degrees with respect to the vertical input end of the input section.

According to an implementation of the first aspect, the bevel box is configured to rotate around the vertical input end of the input section.

According to an implementation of the first aspect, an intermediate shaft connects the first end of the input shaft to the input of the bevel box.

According to an implementation of the first aspect, a cardan shaft connects the intermediate shaft to the input of the bevel box.

Embodiments of the present disclosure provide, in a second aspect, a method for providing of electric power steering (EPS) system for a commercial vehicle. The method comprises: providing an output section configured to mechanically couple with a first end of the output shaft, wherein a second end of the output shaft is configured to connect with a wheel assembly of the electric vehicle; providing an input section having a vertical input end configured to mechanically couple with a first end of the input shaft, wherein a second end of the input shaft is configured to connect with a steering wheel assembly of the electric vehicle, mechanically coupling a bevel box mechanically to the vertical input end of the input section using an adapter plate, the bevel box configured to receive the first end of the input shaft at an angle with respect to the vertical input end of the input section.

According to an implementation of the second aspect, the bevel box comprises an input to receive the first end of the input shaft.

According to an implementation of the second aspect, the angle at which the input of the bevel box is configured to receive the first end of the input shaft is ninety degrees with respect to the vertical input end of the input section.

According to an implementation of the second aspect, the angle at which the input of the bevel box is configured to receive the first end of the input shaft is forty-five degrees with respect to the vertical input end of the input section.

According to an implementation of the second aspect, the bevel box is configured to rotate around the vertical input end of the input section.

According to an implementation of the second aspect, an intermediate shaft connects the first end of the input shaft to the input of the bevel box.

According to an implementation of the second aspect, a cardan shaft connects the intermediate shaft to the input of the bevel box.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates an electric power steering system (EPS) with a bevel box, according to one or more examples of the present disclosure;

FIG. 2 illustrates the EPS system of FIG. 1 as part of a commercial vehicle, according to one or more examples of the present disclosure;

FIG. 3 illustrates the EPS system of FIG. 1 as part of a commercial vehicle, according to one or more examples of the present disclosure;

FIG. 4 illustrates the EPS with another bevel box, according to one or more examples of the present disclosure;

FIG. 5 illustrates the EPS system of FIG. 4 as part of a commercial vehicle, according to one or more examples of the present disclosure; and

FIG. 6 illustrates the EPS system of FIG. 4 as part of a commercial vehicle, according to one or more examples of the present disclosure.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

Electric power steering (EPS) is quickly becoming one of the fastest growing segments in commercial vehicle steering. Commercial vehicle manufacturers are replacing conventional hydraulic power steering systems with full electric power steering systems. In order to optimize existing design of commercial vehicles, EPS systems are supposed to occupy similar space as rotary hydraulic systems along frame rail. The space allocated for rotary hydraulic systems is limited, and does not have flexibility to accommodate new components that accompany the EPS systems. Conventional steering systems are configured to receive an input shaft only along a substantially vertical axis from the steering wheel assembly. The fixed configuration to receive the input shaft in this limited manner leads to a lack of flexibility in design of the EPS systems.

The fixed configuration to receive the input shaft only along the substantially vertical axis leads to a lack of flexibility in design of the EPS systems and does not allow for optimal use of space where the EPS is installed.

In order to optimize the use of space in a driver cab of the commercial vehicle, a bevel gear is installed on the EPS systems that allows to receive the input shaft at an angle with respect to the vertical. For example, the bevel box may be configured to receive the input shaft at a ninety-degree (90°) angle. In another example, the bevel box may be configured to receive the input shaft at a forty-five degree (45°) angle. By allowing the input shaft to be connected to the EPS system at an angle with respect to the vertical, EPS systems may be placed in tight spaces in the bonnet space of commercial vehicles that are previously occupied by hydraulic steering components, such as hoses, filter, reservoir, gear, shaft, and pump).

The bevel box is designed so it is compatible with existing steering wheel assemblies and front axle geometries with minimal modifications, thereby simplifying customer integration. The design of the bevel box is platform agnostic and allows utilization of a common EPS system across multiple platforms and customer applications. The compatible design of the bevel box streamlines development cycles by eliminating real-estate constraints during packaging.

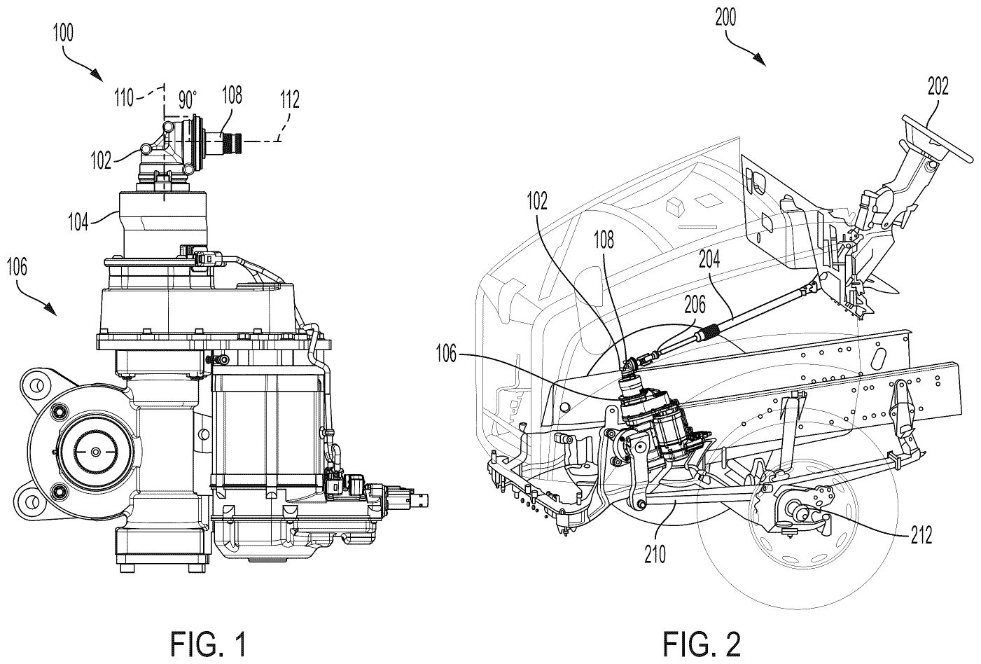

FIG. 1 illustrates an electric power steering system (EPS) with a bevel box, according to one or more examples of the present disclosure. FIG. 1 includes an electric power steering (EPS) system 106. An input section of the EPS system 106 is generally configured to receive an input shaft at an input section along a substantially vertical axis 110. In order optimize the use of space in a driver cab of the commercial vehicle a bevel box 102 is attached to the input section of the EPS 106 via an adapter 104. The bevel box 102 includes an input section 108 that is configured to receive the input shaft. The input section 108 of the bevel box 102 arranged in a direction 112 that is at an angle of ninety degrees (90°) from the substantially vertical axis 110.

FIG. 2 illustrates the EPS system of FIG. 1 as part of a commercial vehicle, according to one or more examples of the present disclosure. FIG. 2 depicts a steering wheel assembly 202 that is connected to an input shaft 204. The input shaft is connected to an intermediate shaft 206, which is connected to input section 108 of the bevel box 102. The bevel box 102 is connected to the EPS system 106. The EPS system 106 is connected to an output shaft 210 that is connected to a wheel assembly 212 of the commercial vehicle. The steering command received from a driver of the commercial vehicle at the steering wheel assembly 202 is transmitted via the input shaft 204 and intermediate shaft 206 to the EPS system 106. The EPS system 106 transmits the steering command received from the user at the steering wheel assembly 202 to a wheel assembly 212 via an output shaft 210.

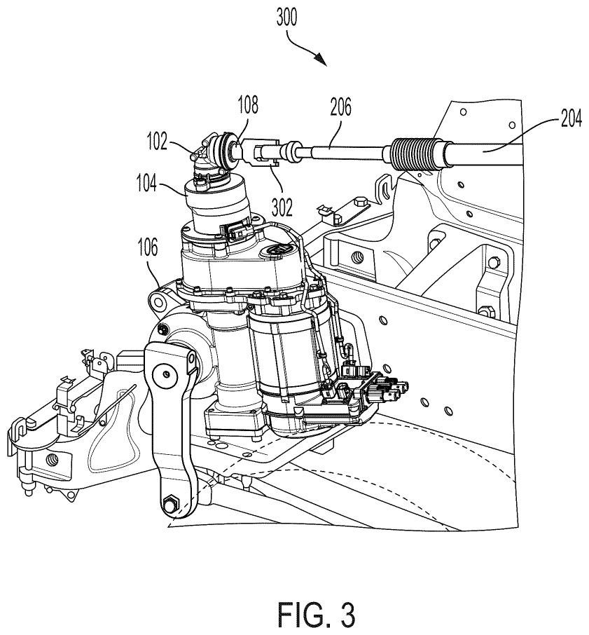

FIG. 3 illustrates the EPS system of FIG. 1 as part of a commercial vehicle, according to one or more examples of the present disclosure. FIG. 3 depicts a portion of FIG. 2 that includes the input shaft 204 connected to the intermediate shaft 206. The intermediate shaft 206 is connected to the output section 108 of the bevel box 102 via a cardan shaft 302. The bevel box 102 is connected to the EPS system 106 of a commercial vehicle via an adapter 104.

In some embodiments, the steering command provided by a user at the steering wheel assembly 302 may cause axial rotation of the input shaft 204. The axial rotation of the input shaft 204 causes axial rotation of the intermediate shaft 206. The axial rotation of the intermediate shaft 206 is transmitted to the input section 108 of the bevel box 102 via rotation of the cardan shaft 102. As is shown in FIG. 3, the intermediate shaft 206 is connected to the bevel box at an angle of approximately ninety degrees (90°) with respect to the substantially vertical axis.

The bevel box 102 converts the axial rotations received from the intermediate shaft 206, at an angle of ninety-degrees with respect to the substantially vertical axis, to an input along the substantially vertical axis that is provided to the EPS system 106. The EPS system 106 processes the steering command received along the substantially vertical axis 110 and provides a steering output to output shaft 210. The steering output provided to output shaft 210 causes the steering of the wheel assembly 212 connected to output shaft 210.

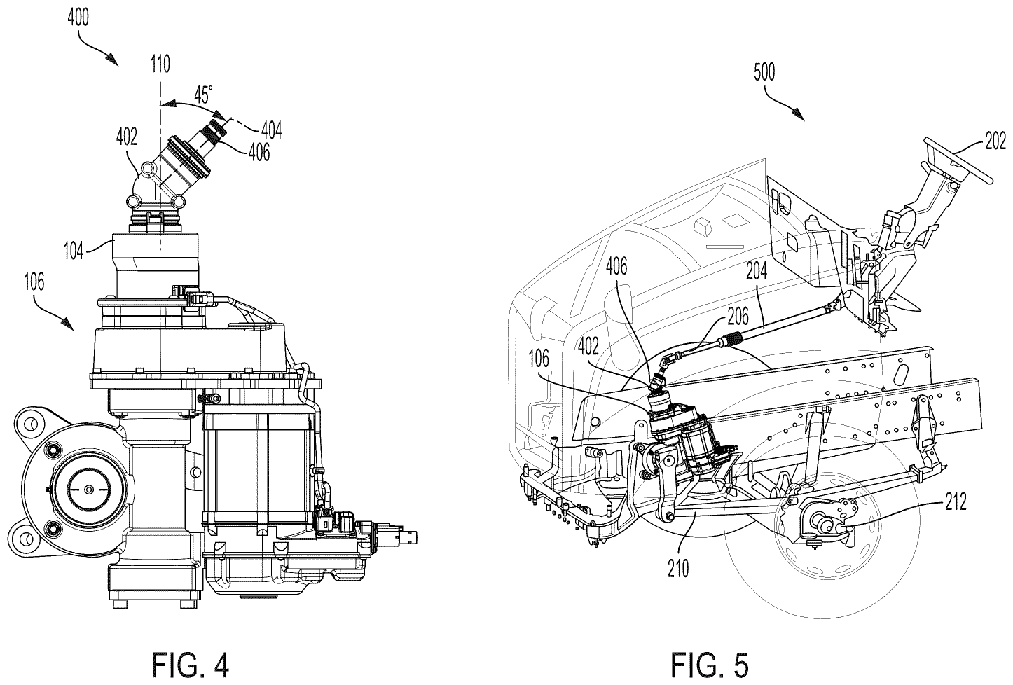

FIG. 4 illustrates the EPS with another bevel box, according to one or more examples of the present disclosure. FIG. 4 includes the electric power steering (EPS) system 106. As discussed with respect to FIG. 1, the input section of the EPS system 106 is generally configured to receive an input shaft at an input section along the substantially vertical axis 110. In order optimize the use of space in a driver cab of the commercial vehicle a bevel box 402 is attached to the input section of the EPS 106 via an adapter 104. The bevel box 402 includes an input section 406 that is configured to receive the input shaft. The input section 406 of the bevel box 402 is arranged in a direction 404 that is at an angle of forty-five degrees (45°) from the substantially vertical axis 110.

FIG. 5 illustrates the EPS system of FIG. 2 as part of a commercial vehicle, according to one or more examples of the present disclosure. FIG. 5 depicts a steering wheel assembly 202 that is connected to an input shaft 204. The input shaft is connected to an intermediate shaft 206, which is connected to input section 406 of the bevel box 402. The bevel box 402 is connected to the EPS system 106. The EPS system 106 is connected to an output shaft 210 that is connected to a wheel assembly 212 of the commercial vehicle. The steering command received from a driver of the commercial vehicle at the steering wheel assembly 202 is transmitted via the input shaft 204 and intermediate shaft 206 to the EPS system 106. The EPS system 106 transmits the steering command received from the user at the steering wheel assembly 202 to a wheel assembly 212 via an output shaft 210.

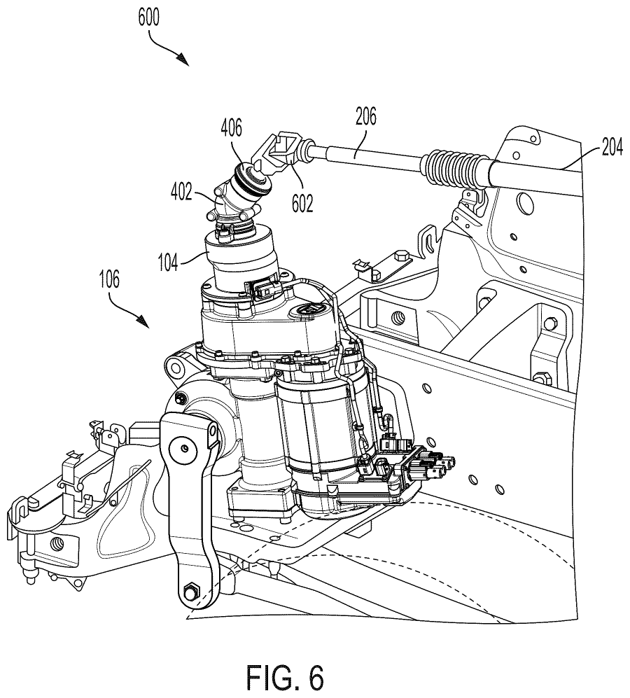

FIG. 6 illustrates the EPS system of FIG. 4 as part of a commercial vehicle, according to one or more examples of the present disclosure. FIG. 6 depicts a portion of FIG. 5 that includes the input shaft 204 connected to the intermediate shaft 206. The intermediate shaft 206 is connected to the output section 406 of the bevel box 402 via a cardan shaft 602. The bevel box 402 is connected to the EPS system 106 of a commercial vehicle via an adapter 104.

In some embodiments, the steering command provided by a user at the steering wheel assembly 202 may cause axial rotation of the input shaft 204. The axial rotation of the input shaft 204 causes axial rotation of the intermediate shaft 206. The axial rotation of the intermediate shaft 206 is transmitted to the input section 406 of the bevel box 402 via rotation of the cardan shaft 602. As is shown in FIG. 6, the intermediate shaft 206 is connected to the bevel box at an angle of approximately forty-five degrees (45°) with respect to the substantially vertical axis.

The bevel box 402 converts the axial rotations received from the intermediate shaft 206, at an angle of forty-five degrees with respect to the substantially vertical axis, to an input along the substantially vertical axis that is provided to the EPS system 106. The EPS system 106 processes the steering command received along the substantially vertical axis 110 and provides a steering output to output shaft 210. The steering output provided to output shaft 210 causes the steering of the wheel assembly 212 connected to output shaft 210.

In some embodiments, the input section 108 (or input section 406) of the bevel box 102 (or the bevel box 402) may be configured to receive input from the input shaft 204 at any angle, based on the space constraints of the commercial vehicle. For example, the input section 108 (or input section 406) of the bevel box 102 (or the bevel box 402) is arranged in a direction that is at any angle value between zero degrees (0°) and of ninety degrees (90°) from the substantially vertical axis 110 to optimize the design of the steering column and engine design of the commercial vehicle.

In some other embodiments, the input section 108 (or input section 406) of the bevel box 102 (or the bevel box 402) may be configured to rotate around the substantially vertical axis 110. In this way, the input section 108 of the bevel box 102 may be configured to receive the intermediate shaft 206 and the input shaft 206 in any direction at any angle, helping to optimize the design of the steering column and engine design of the commercial vehicle.

In this way, the input section 108 of the bevel box 102 may be configured to receive the intermediate shaft 206 and the input shaft 206 in any direction at any angle, helping While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An electric power steering (EPS) system for a commercial vehicle, the EPS system comprising:
an output section configured to mechanically couple with a first end of the output shaft, wherein a second end of the output shaft is configured to connect with a wheel assembly of the electric vehicle;
an input section having a vertical input end configured to mechanically couple with a first end of the input shaft, wherein a second end of the input shaft is configured to connect with a steering wheel assembly of the electric vehicle,
wherein the input section further comprises:
a bevel box mechanically coupled to the vertical input end of the input section using an adapter plate, the bevel box configured to receive the first end of the input shaft at an angle with respect to the vertical input end of the input section.

2. The electric power steering system of claim 1, wherein the bevel box comprises an input to receive the first end of the input shaft.

3. The electric power steering system of claim 2, wherein the angle at which the input of the bevel box is configured to receive the first end of the input shaft is ninety degrees with respect to the vertical input end of the input section.

4. The electric power steering system of claim 2, wherein the angle at which the input of the bevel box is configured to receive the first end of the input shaft is forty-five degrees with respect to the vertical input end of the input section.

5. The electric power steering system of claim 1, wherein the bevel box is configured to rotate around the vertical input end of the input section.

6. The electric power steering system of claim 2, wherein an intermediate shaft connects the first end of the input shaft to the input of the bevel box.

7. The electric power steering system of claim 6, wherein a cardan shaft connects the intermediate shaft to the input of the bevel box.

8. A method for providing an electric power steering (EPS) system for a commercial vehicle, the method comprising:
providing an output section configured to mechanically couple with a first end of the output shaft, wherein a second end of the output shaft is configured to connect with a wheel assembly of the electric vehicle;
providing an input section having a vertical input end configured to mechanically couple with a first end of the input shaft, wherein a second end of the input shaft is configured to connect with a steering wheel assembly of the electric vehicle,
mechanically coupling a bevel box to the vertical input end of the input section using an adapter plate, the bevel box configured to receive the first end of the input shaft at an angle with respect to the vertical input end of the input section.

9. The method of claim 8, wherein the bevel box comprises an input to receive the first end of the input shaft.

10. The method of claim 9, wherein the angle at which the input of the bevel box is configured to receive the first end of the input shaft is ninety degrees with respect to the vertical input end of the input section.

11. The method of claim 9, wherein the angle at which the input of the bevel box is configured to receive the first end of the input shaft is forty-five degrees with respect to the vertical input end of the input section.

12. The method of claim 8, wherein the bevel box is configured to rotate around the vertical input end of the input section.

13. The method of claim 9, wherein an intermediate shaft connects the first end of the input shaft to the input of the bevel box.

14. The method of claim 13, wherein a cardan shaft connects the intermediate shaft to the input of the bevel box.
